(19) United States
(12) Patent Application Publication
(10) Pub. No.: US 2026/0243415 A1
(43) Pub. Date: Aug. 20, 2026

(54) DRIVING APPARATUS FOR ONE OR MORE LED ARRANGEMENTS

(71) Applicant: SIGNIFY HOLDING B.V., EINDHOVEN (NL)

(72) Inventors: YINGYING WANG, SHANGHAI (CN); XIANGYU DING, SHANGHAI (CN); YAQIONG ZHANG, SHANGHAI (CN); JIBO YAN, SHANGHAI (CN)

(21) Appl. No.: 18/876,709

(22) PCT Filed: Jun. 19, 2023
(86) PCT No.: PCT/EP2023/066485

§ 371 Date: Dec. 19, 2024

(30) Foreign Application Priority Data
Jun. 24, 2022 (WO) PCT/CN2022/101197
Aug. 23, 2022 (EP) 22191593.7

(51) Int. Cl. F21V 23/06; F21V 23/00; F21Y 115/10; H05B 45/20; H05B 45/30; H05B 47/155

(52) U.S. Cl. CPC F21V 23/06; F21V 23/001; F21V 23/007; H05B 45/20; H05B 45/30; H05B 47/155; F21Y 2115/10

(57) ABSTRACT

A driving apparatus for one or more LED arrangements. A power supply, housed in a housing, provides two or more supply signals, each provided to a supply terminal on the housing. One or more LED interfaces are also located on the housing, for connecting to one or more LED arrangements. Each LED interface is connected to an interconnection terminal, also located on the housing. One or more detachable interconnection components can be used to bridge or connect any of the supply terminals with an interconnection mode, to thereby control which supply signal is passed, or whether a supply signal is passed, to the LED interface(s).

### FIELD OF THE INVENTION

The present invention relates to the field of driving apparatuses, and in particular, to driving apparatuses for LED arrangements.

### BACKGROUND OF THE INVENTION

It is common for driving apparatuses, having a power supply, for one or more LED arrangements to comprise a switch on the housing of the driving apparatus to facilitate switching (connection and disconnection) of the LED arrangement from the power supply, or switching how much current provided to the LED arrangement. Any such switches have a maximum rated voltage for which they are designed to operate with minimal risk of breakage or short-circuiting. Typically, the larger the rated voltage, the bulkier and more materially expensive the switch. Currently, there are products that use a dip switch to adjust the output current, wherein the dip switch may be placed in a low voltage control loop to adjust the control parameter. If the switch needs to be placed in the power loop, such that the LED current going through the switch, the rated voltage on the switch is quite high, and therefore a large switch is needed to meet the safety requirements. This large switch is difficult to be placed in the driving apparatus.

There is therefore a desire to improve the robustness of driving apparatuses with such a switching ability in high voltages, as well as to reduce a material cost of any such driving apparatuses.

US20120262076A1 discloses a LED lighting apparatus with a power supply, a control unit and a light engine with different LED sets. The control unit has a common supply connected to the different LED sets and the power supply, respective return paths connected to each LED set, and respective switching element in the control unit to close or open the corresponding return path back to the power supply. The switching elements are electrically controlled by a controller in the control unit.

US20120063138A1 discloses a system with nodes carrying power supply and communication module, and rails connecting adjacent nodes and carrying LEDs, power and/or communication channels.

### SUMMARY OF THE INVENTION

The invention is defined by the claims.

The inventors have identified that the presence of switches in a driving apparatus for an LED arrangement can significantly impact the cost and/or design of the driving apparatus. The current requirement or use of switches therefore places a significant burden on the amount of circuitry required for, as well as impacting the size of, the driving apparatus.

The present disclosure proposes an approach to overcoming this problem. In particular, in cases that the power loop of the driver needs to be switched, rather than using a standalone switch in the power loop to select which of a plurality of supply signals are provided to a LED arrangement, connection terminals/nodes and detachable interconnection elements (e.g., detachable wires) can be used in the switch's place in the power loop. The connection terminals can be easily distanced on the housing of the driving apparatus by a distance meeting the safety creepage requirement. The inventors have identified that, in many cases, connecting those terminals with the interconnection element is a convenient operation for an end user/personnel to easily modify which supply signal is provided to an LED arrangement, which is same easy as he connects output terminals to the LED module. Thus, the driving apparatus with the switching ability can meet the safety requirement, the need for standalone switches is alleviated, and the material and financial cost of a driving apparatus can be reduced.

According to examples in accordance with an aspect of the invention, there is provided a driving apparatus with a housing.

The driving apparatus comprises a power supply, contained inside the housing, configured to provide a first supply signal and a second supply signal; at least one LED interface on the housing, each LED interface being configured to connect to a respective LED arrangement; at least one interconnection terminal on the housing, each interconnection terminal being electrically connected to a respective LED interface, a first supply terminal on the housing and being connected to the power supply and configured to receive the first supply signal from the power supply; a second, different supply terminal on the housing and being connected to the power supply and configured to receive the second supply signal from the power supply.

The first supply terminal and the second supply terminal and each interconnection terminal are distanced with each other on the housing and configured to connect to a detachable interconnection component different from the LED arrangement and allow, when one of the supply terminals is connected to a particular interconnection terminal via the detachable interconnection component, the corresponding supply signal to flow to the LED interface connected to the particular interconnection terminal via the connected supply terminal and particular interconnection terminal.

Put another way, the first supply terminal and each of a first set of one or more interconnection terminals may be configured to, when connected via a first detachable interconnection component, allow the first supply signal to flow from the first supply terminal to the connected interconnection terminal, wherein the first detachable interconnection component is configured to be detachable from the first supply terminal and/or each of the first set of one or more interconnection terminals.

Similarly, the second supply terminal and each of a second set of one or more interconnection terminals may be configured to, when connected via a second detachable interconnection component, allow the second supply signal to flow from the second supply terminal to the connected interconnection terminal, wherein the second detachable interconnection component is configured to be detachable from the second supply terminal and/or each of the second set of one or more interconnection terminals.

The proposed approach provides a technique for choosing which supply signal (if there are two or more available supply signals), or whether a supply signal, is provided to one or more LED interfaces (and therefore one or more connected LED arrangements) without the use of a standalone switch. The safety creepage requirement is met by the supply output terminal and the interconnection terminal. This approach thereby reduces or avoids the use of switches in a driving arrangement, reducing a cost and/or size of the driving apparatus and/or avoiding rating limitations of switches.

Embodiments are particularly advantageous when considered in the context of a manufacturing mechanism. In particular, during a first stage of manufacturing, a single driving apparatus can be manufactured for multiple different end uses. During a second stage of assembling, depending upon the end use, the selection of which supply signal, or whether a supply signal, is provided to each LED interface can be made by selectively connecting the proper terminals via an external interconnection component. Proposed embodiments are particularly useful in such scenarios, as there is little need or only limited scope for modifying which LED interfaces are to be driven during later use.

Optionally, for each supply terminal, a distance between the connected supply terminal and particular interconnection terminal is no less than a creepage distance corresponding to a voltage of the supply signal provided to the supply terminal. Usually the higher the voltage the longer the creepage distance. Thus the distance between the terminals can be chosen according to the practical voltage, e.g., for which the driving apparatus is designed. This improves a safety of the driving apparatus, reducing a change of an unintended short circuit or driving of any connected LED arrangements. The present invention is particularly advantageous in avoiding (voltage) rating limitations of switches.

Optionally, for each supply terminal, a distance between the supply terminal and any interconnection terminal is no less than a creepage distance corresponding to the voltage of the supply signal provided to the supply terminal.

In some examples, the power supply is a non-isolated power-supply. The terminals in non-isolated power supply may electrically connect to the AC mains input thus ensuring the creepage distance is preferable for such power supply. This provides a low cost and highly efficient power supply for driving any connected LED arrangements.

In some examples, one of the interconnection terminals is fixedly attached to a first detachable interconnection component while the first supply terminal and/or second supply terminal is attachably and detatchably connectable to the first detachable interconnection component.

In some examples, for at least one interconnection terminal, the interconnection terminal is fixedly attached to a detachable interconnection component which is attachable and detatchable from the first supply terminal and/or second supply terminal.

In some examples, the first supply terminal or second supply terminal is fixedly attached to a second detachable interconnection component while the interconnection terminal is attachably and detatchably connectable to the second detachable interconnection component.

In some examples, the first detachable interconnection component is fixedly attached to the first supply terminal and is attachable to and detatchable from each of the first set of one or more interconnection terminals; and/or the second detachable interconnection component is fixedly attached to the second supply terminal and is attachable to and detatchable from each of the second set of one or more interconnection terminals.

These approaches provide mechanisms for reducing a likelihood that the detachable interconnection component will be lost, whilst still providing choice and flexibility for which supply signal, if any, is provided to one or more LED interfaces.

In some examples, each of the supply terminals and interconnection terminals is attachably and detachably connectable to a third detachable interconnection component. In some examples, none of the supply terminals or interconnection terminals is fixedly attached to any detachable interconnection component.

These approaches reduce a complexity of manufacturing the driving apparatus whilst maintaining a flexibility in choosing which supply signal, if any, is provided to one or more LED interfaces.

In an embodiment for two or more lighting channels, the at least one LED interface may comprise at least two LED interfaces, and the at least one interconnection terminal comprises at least two interconnection terminals. This approach allows for multiple LED arrangements to be coupled to the driving apparatus, and allows for selection of which LED arrangements are to be driven by the driving apparatus, providing a more flexible luminaire.

The driving apparatus may comprise: a first LED interface configured to connect to a first LED arrangement; a second, different LED interface configured to connect to a second LED arrangement; a first interconnection terminal electrically connected to the first LED interface, and a second interconnection terminal electrically connected to the second LED interface.

The first supply terminal may be adapted to be connectable to the first interconnection terminal via a detachable interconnection component, and the second supply terminal may be adapted to be connectable to the second interconnection terminal via another detachable interconnection component.

Optionally, the first LED arrangement is configured to generate light having at least one different characteristic from that of the second LED arrangement. For instance, the at least one different characteristic may be a color and/or color temperature.

One or both of the first and second interconnection terminals may be adapted to connect to the corresponding supply terminal via a detachable interconnection component, so as to provide a selected one or both of the first and the second LED arrangement with one or both of the first and second supply signals respectively.

In this embodiment, color tuning/color temperature tuning is implemented.

Alternatively, the first and second LED arrangements can be with same characteristic. In this embodiment, the driving apparatus is a universal driver for a single or double channels.

In an alternative embodiment for only one lighting channel, both of the first supply terminal and the second supply terminal may be adapted to be connectable to the interconnection terminal via a detachable interconnection component. The power supply may comprise a current setting arrangement configured to set a first current for the first supply signal and a second, different current for the second supply signal. A selected one of the first and second supply terminals may be adapted to connect to a detachable interconnection component with the interconnection terminal, so as to provide the LED arrangement with a selected one of the first supply signal and the second supply signal.

This embodiment provides a dimming ability to a single lighting channel, via the terminals and the interconnection component.

More generally, the power supply may comprise a current setting arrangement configured to set a first current for the first supply signal and a second, different current for the second supply signal. This approach allows for selection of different currents to be provided to the LED interface, and thereby different currents to any connected LED arrangement(s). This provides a technique for controlling/dimming the intensity of light output by a luminaire comprising the driving apparatus.

The above channel selection or dimming provide flexibility for the luminaire makers: the luminaire make can order just one single model of the driving apparatus as above, assemble the driving apparatus into different type of luminaire with different configuration of LED channels, and configure the driving apparatus to provide different output according to the different configuration of LED channels. This reduces the stocking pressure of the luminaire maker as well as the driving apparatus maker.

Optionally, the current setting arrangement comprises a series interconnection of current setting resistances; the first supply terminal is connected in series to a first tap in the series interconnection of current setting resistances; and the second supply terminal is connected in series to a second, different tap in the series interconnection of current setting resistances. This approach provides a simple and materially cheap mechanism for dimming/providing different currents for different supply signals.

The terminals, i.e., the supply terminals and/or interconnection terminal(s), may be wire terminals. Wire terminals provide a cheap and effective mechanism for connecting to interconnection element in a detachable manner.

There is also provided an LED driver kit comprising any herein descried driving apparatus; and at least one detachable interconnection component. The detachable interconnection component may be a jump wire, to provide an effective and low cost detachable interconnection component.

There is also provided an LED luminaire comprising: the LED driver kit previously described; and the first LED arrangement comprising one or more light emitting diodes, a first LED arrangement being connected to a first one of the at least one LED interfaces.

The at least one LED interfaces may comprise two or more LED interfaces and further comprising a second, different LED arrangement connected to a second, different one of the at least one LED interfaces.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a driving apparatus according to an embodiment;

FIG. 2 illustrates a power supply for use in a driving apparatus in FIG. 1;

FIG. 3 illustrates a driving apparatus according to another embodiment; and

FIG. 4 illustrates the driving apparatus of FIG. 3 in a realistic form.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a driving apparatus for one or more LED arrangements. A power supply, housed in a housing, provides two or more supply signals, each provided to a supply terminal on the housing. One or more LED interfaces are also located on the housing, for connecting to one or more LED arrangements. Each LED interface is connected to an interconnection terminal, also located on the housing. One or more detachable interconnection components can be used to bridge or connect any of the supply terminals with an interconnection mode, to thereby control which supply signal is passed, or whether a supply signal is passed, to the LED interface(s). By using the supply terminals and the interconnection terminal decoupled from each other on the driving apparatus per se, the creepage requirement is met. A switch is not needed.

In the context of the present invention, the term “detachable” means that an element can be attached to and detached from another element by a human (with or without using dedicated or specific tools such as a soldering iron). Thus, the first supply terminal and the second supply terminal and each interconnection terminal are on an external surface of the housing and configured to be manually connected to the external detachable interconnection component. Preferably the attachment uses a human level of force (e.g., <5N) and without a need to break or damage either of the elements.

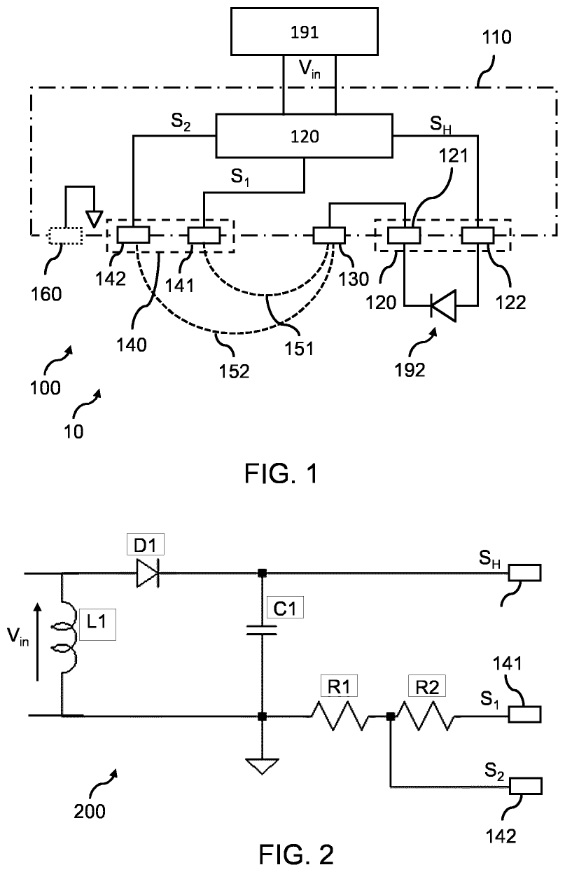

FIG. 1 schematically illustrates a driving apparatus 100 according to an embodiment. FIG. 1 also illustrates an LED luminaire 10 according to an embodiment, which comprises the driving apparatus 100.

The driving apparatus 100 comprises a housing 110 illustrated by the dash-dot line, which houses or encloses a power supply 120. The power supply is configured to generate or provide at least one supply signal, e.g., convert an input signal provided from an external power supply 191. The power supply 120 may have a double stage configuration, including a PFC stage and a DC-DC stage, or be a single stage. The external power supply 191 may, for instance, be a mains power supply or an electronic ballast.

The housing may be formed of any suitable material. In one example, it is an electrically insulating material such as plastic. However, in other examples such as outdoor lighting, the housing may be formed of other materials such as metals or ceramics.

The driving apparatus 100 further comprises a first LED interface 120. The first LED interface 120 is configured to connect to a first LED arrangement 192 of the LED luminaire. The first LED interface is located on the housing, e.g., is exposed outside of the driving apparatus. The first LED arrangement may comprise a string of one or more light emitting diodes (LEDs).

In the context of the present invention, an element that is on the housing is an element at a position at which the housing exposes or does not cover the element such that it is accessible by the personnel.

The illustrated first LED interface 120 comprises a first, negative LED terminal 121 and a second, positive LED terminal 122, between which the first LED arrangement 192 is connectable. The second LED terminal 122 may, for instance, connect to the power supply 120 (e.g., to provide a path or return path for current).

The driving apparatus further comprises an interconnection interface on the housing. The interconnection interface comprises, for each LED interface 120, an interconnection terminal 130, e.g., at least a first interconnection terminal 130. Each interconnection terminal 130 is connected to its respective LED interface 120 within the driving apparatus, illustrated by a solid line.

The driving apparatus 100 further comprises a first supply terminal 141 and a second supply terminal 142, both of which are positioned on the housing 110. The first 141 and second 142 supply terminals are both connected to the power supply 120 and configured to receive a respective supply signal from the power supply 120. Thus, the first supply terminal 141 receives a first supply signal S₁ from the power supply 120 and the second supply terminal 142 receives a second supply signal S₂ from the power supply 120.

The first supply terminal 141 and the second supply terminal 142 may be considered to form part of a supply output interface 140.

The interconnection terminal 130 and the first supply terminal 141 are configured such that a first detachable interconnection component 151 is able to form a first channel or current path between the first supply terminal 141 and one of the interconnection terminal(s) 130 of the interconnection interface. In the present example, the interconnection interface 130 comprises a single terminal, such that the first detachable interconnection component is able to form a first channel between the first supply terminal 141 and the first interconnection terminal 130.

When the first channel is formed, the first supply signal is permitted/allowed to flow from the first supply terminal 141 to the connected first interconnection terminal 130 (and thereby any LED arrangement 192 connected to the first LED interface 120). Thus, current is able to flow through an LED arrangement 192 connected to the first LED interface 120.

The interconnection terminal 130 and the second supply terminal 142 are configured such that a second detachable interconnection component 152 is able to form a second channel between the second supply terminal 142 and one of the interconnection terminal(s) 130 of the interconnection interface. In the present example, the interconnection interface 130 comprises a single terminal, such that the second detachable interconnection component is able to form a second channel between the second supply terminal 142 and the first interconnection terminal 130.

When the second channel is formed, the second supply signal is permitted/allowed to flow from the second supply terminal to the connected first interconnection terminal 130 (and thereby any connected LED arrangement 130).

The driving apparatus and the detachable interconnection element(s) together provide an LED driver kit according to an embodiment.

The first detachable interconnection component 151 is configured to be detachable from the first supply terminal 141 and/or the first interconnection terminal 130. Similarly, the second detachable interconnection component 152 is configured to be physically detachable from the second supply terminal 142 and/or the first interconnection terminal 130.

In some examples, the/each detachable interconnection component is fixedly secured to one of the supply terminals or the first interconnection terminal, but detachable from the other of the one of the supply terminals and the first interconnection terminal.

If fixedly secured to the first interconnection terminal, then the first detachable interconnection component and the second detachable interconnection component may be the same detachable interconnection component. This reduces a number of component parts required. However, in other examples, the first and second detachable interconnection components may be different detachable interconnection components that are both fixedly attached to the first interconnection terminal.

If fixedly secured to one of the supply terminals, then the first detachable interconnection component and the second detachable interconnection component are different detachable interconnection components. Thus, in such examples, the first detachable interconnection component is fixedly secured to the first supply terminal and the second detachable interconnection component is fixedly secured to the second supply terminal.

In other examples, the/each detachable interconnection component is detachable from the supply terminal(s) and the first interconnection terminal. Thus, each detachable interconnection component may be fully removable from the remainder of the driving apparatus. In some examples, there may only be a single detachable interconnection component, which can selectively connect between the first supply terminal and the first interconnection mode or the second supply terminal and the first interconnection terminal.

Suitable example of a detachable interconnection component includes a jump wire.

It is noted that the schematic illustration of FIG. 1 illustrates the potential detachable interconnect component 152 (e.g., a wire) flying over the supply terminal 141. This is only a logic schematic showing the electrically connection between the terminals. In a real product, the interconnection terminal 130 can be placed between the terminals 141 and 142, and the wire connecting the interface terminal 130 and one supply terminal would therefore not go over the other supply terminal.

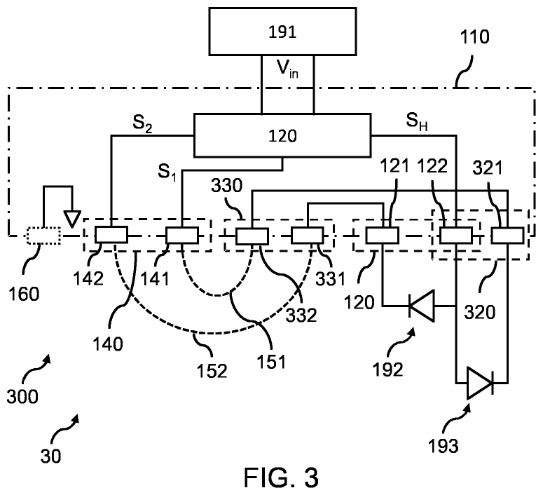

In further embodiments, the terminal 130 can be split into two separate terminals or sub-terminals connected together internally within the driving apparatus, e.g., within the housing 110, and each terminal is close/proximate to a different supply terminal for a wire connection without flying over any other terminal. This approach also applies to the driving apparatus described with reference to FIG. 3 below.

With continued reference to FIG. 1, preferably, for the illustrated scenario where the driving apparatus comprises a single LED interface 120, the first supply signal S₁ and the second supply signal S₂ have different electrical characteristics, e.g., a different voltage, a different current and/or a different power. This facilitates a mechanism for changing and controlling the power provided to the first LED arrangement 192 using the detachable interconnection component(s).

However, this is not essential. For instance, the first supply signal and the second supply signal may have identical (or near-identical) electrical characteristics. This can be used for redundancy purposes, e.g., if there is a problem with a connection between the power supply and one of the supply terminals 141, 142.

In some embodiments, the driving apparatus 100 may further comprise a ground terminal 160 on the housing, connected to a ground or reference voltage. The ground terminal may be connectable to the first supply terminal 131 or the second supply terminal 132, e.g., via a detachable interconnection component. This approach can avoid/prevent exposure of the supply terminal(s) and thereby increase a safety of the driving apparatus.

Preferably, for each supply terminal, a distance between the supply terminal and any interconnection terminal is no less than a creepage distance corresponding to the voltage of the supply signal provided to the supply terminal. A corresponding creepage distance is a distance along which a signal having a particular voltage is able to migrate (e.g., within known safety margins). Approaches for determining a creepage distance are well established in the art. Examples are set out in the IEC 60601-1 standard, and could be employed in the present disclosure. In real product, a few mm distance between the terminals is sufficient and can be realized easily; whereas providing a few mm creepage distance via a standalone switch is not easy but requires a switch with a much larger total size/footprint.

FIG. 2 illustrates a power supply 200 for use in the previously described driving apparatus of FIG. 1. The power supply 200 is configured to generate two supply signals S₁, S₂ having different electrical characteristics. Thus, each supply signal effectively has a different setting for powering an LED arrangement.

The power supply 200 is a non-isolated power-supply.

The power supply 200 comprises a power commutation inductor L1, and output capacitor C1 and a rectifying diode D1 for producing a DC signal, e.g., across the capacitor C1. The power supply 200 in FIG. 2 could be a buck-boost type, while other types are also applicable.

The power supply 200 further comprises a first current setting arrangement R1, R2. The first current setting arrangement is configured to set a first current for the first supply signal S₁, which is provided to an LED interface when the corresponding interconnection terminal for that LED interface is coupled to the first supply terminal 141 (via a detachable interconnect component).

The power supply 200 also comprises a second current setting arrangement R1. The second current setting arrangement is configured to couple to the second interconnection interface and is configured to set a second, different current for the second supply signal, which is provided to an LED interface when the corresponding interconnection terminal for that LED interface is coupled to the second supply terminal 141 (via a detachable interconnect component).

The first and second current setting arrangement may, as illustrated, be combined into a combined current setting arrangement R1, R2. The combined current setting arrangement may comprise a series interconnection of current setting resistances R1, R2.

The first supply terminal 141 may be connected in series to a first tap in the series interconnection of current setting resistances. The second supply terminal 142 may be connected in series to a second, different tap in the series interconnection of current setting resistances. Effectively, the current set by the series resistors is smaller than the current set by the single resistor.

FIG. 3 illustrates a driving apparatus 300 according to another embodiment. As before, FIG. 3 also illustrates an LED luminaire 30 according to an embodiment, which comprises the driving apparatus 100.

The driving apparatus 300 differs from the driving apparatus of FIG. 1 by further comprising a second LED interface 320 on the housing 110 and that the driving apparatus 300 comprises a first interconnection terminal 331 and a second, different interconnection terminal 332.

The first interconnection terminal 331 and the second interconnection terminal 332 may be considered too together form an interconnection interface 330.

Each interconnection terminal 331, 332 is electrically connected to a respective, different LED interface 120, 320. Thus, the first interconnection terminal 331 is electrically connected to the first LED interface 120 and the second interconnection terminal 332 is electrically connected to the second LED interface 320.

The second LED interface comprises a third LED terminal 321 and a fourth LED terminal 122, between which a second LED arrangement 193 of the LED luminaire 10 is connectable. The fourth LED terminal 122 may, as illustrated, be the same as the second LED terminal. Alternatively, the fourth LED terminal may be a different LED terminal connected also to the SH output of the power supply. In any event, the fourth LED terminal may connect to the power supply 120 (e.g., to provide a path or return path for current).

Each supply terminal 141, 142 is configured to be connectable (via a detachable interconnection component 151, 152) to one of the two interconnection terminals 331, 332 respectively. Similarly, each interconnection terminal is configured to be connectable (via a detachable interconnection component 151, 152) to one supply terminal. Preferably, each interconnection terminal is only able to be connected to a single supply terminal at a time.

In this way, it is possible to choose which one or both of the two LED interfaces are provided with a supply signal from the power supply. This provides improved flexibility for choosing which supply signals are used to power or drive any LED arrangements connected to any of the LED interfaces.

In some examples, each supply terminal 141, 142 may be connectable to any one of the interconnection terminals 331, 331 (of the interconnection interface 330). In this way, different supply signals can be provided to different interconnection terminals and thereby different LED interfaces (and therefore different LED arrangements). Here different supply signals do not necessarily mean the amplitude of the supply signals are different, but means the power loops of the two interfaces are different.

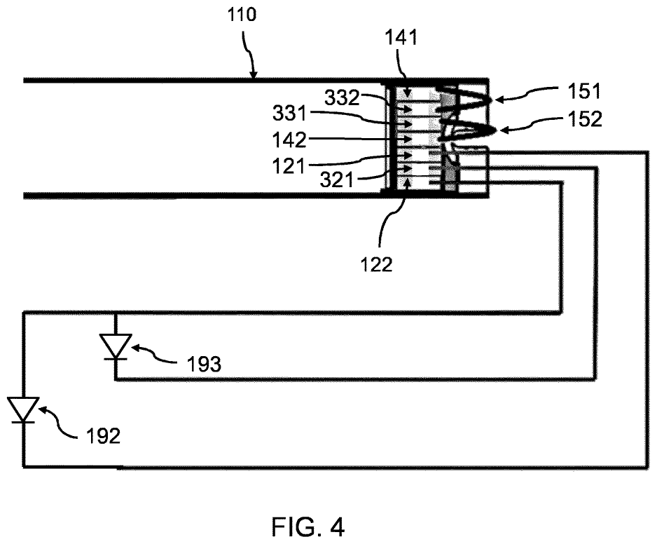

FIG. 4 shows the driving apparatus in a realistic and standard form, wherein the connection between terminals 321 and 332 and the connection between terminals 121 and 331 are internal within the housing 110 of the driving apparatus and are not shown for simplicity.

This approach provides a mechanism for controlling the electrical characteristics of a supply signal that drives the LED arrangement(s). This approach also always for selection of which interconnection terminals are provided with a supply signal, and therefore which LED interfaces are driven by a supply signal.

For instance, if the supply signals have different current amplitudes, it is possible to control or select the magnitude of light output by each LED arrangement connected to the LED interfaces.

As previously explained, the first supply signal and the second supply signal may have different electrical characteristics, e.g., a different voltage, a different current and/or a different power.

In some examples, the driving apparatus may be configured such that at least one of the supply terminals is only able to connect to one of a subset (i.e., not all) of the interconnection terminals. This restricts which LED interfaces are able to be driven by particular supply signals (e.g., if the supply terminals are provided with different supply signals). This can prevent, for instance, certain LED interfaces from being powered by a potentially dangerous supply signal, e.g., an overcurrent or overvoltage.

In some examples, each supply terminal is only able to connect (via a respective detachable interconnection component) to a single interconnect terminal. This approach reduces a change of an incorrect attachment between different supply terminals and interconnect terminals, and finds a particular advantage when each supply signal is designed for a specific LED arrangement or load.

Each detachable interconnection component is configured to be detachable from at least one supply terminal 141, 142 and/or at least one interconnection terminal 331, 332.

In some examples, the/each detachable interconnection component is fixedly secured to one of the supply terminals or one of the interconnection terminals, but is detachable from:
if secured to one of the supply terminals, at least one interconnection terminal; or, if secured to one of the interconnection terminals, at least one supply terminal.

In other examples, the/each detachable interconnection component is detachable from a set of one or more supply terminals and a set of one or more interconnection terminals. Thus, each detachable interconnection component may be fully removable from the remainder of the driving apparatus.

It is possible that more than one detachable interconnection component may be coupled to a single supply terminal at a same time. This allows a same supply signal to be provide to different interconnection terminals, and thereby different LED interfaces.

The first LED arrangement 192 may be configured to generate light having at least one different characteristic from that of the second LED arrangement 193. For instance, the at least one different characteristic may be a color and/or color temperature.

This approach allows for control over the mix of colors or color temperatures output by the LED luminaire. This approach is particularly advantageous when any of the supply terminals can be connected to any of the interconnection terminals via a respective detachable interconnection component, as it allows for a large variety of different mixes of colors or color temperatures to be selected.

Table 1 illustrates a scenario in which a set of one or more “warm” LEDs (e.g., having a color temperature of 2700K) is connected to the first LED interface 120 and a set of one or more “cold” LEDs (e.g., having a color temperature of 6500K for example) is connected to the second LED interface 320. In this scenario, assume the electrical current amplitude of the two supply signals provided at the S₁ and S₂ are the same. The mixed color temperature could be 4100K.

TABLE 1

| Terminal Connection(s) | Overall Color Temperature |
|---|---|
| Only 331 to 142 | Warm |
| Only 332 to 141 | Cold |
| 331 to 142 and 332 to 141 | Mixed |

As to the power supply for use in the driving apparatus in FIG. 3, a double channel driver with a single positive output and two respective negative output can be used, wherein the single positive output is connected to SH, and two respective negative outputs can be connected to S₁ and S₂ respectively.

Other variations for a power supply would be readily apparent to the skilled person.

Proposed embodiments are particularly advantageous when the/each supply signal has a voltage greater than 24 or 36. High voltages preclude the use a large number of switches, due to their limited rated voltage. The present approach makes use of a detachable interconnection component, which avoids the rating limitation of switches whilst remaining compact in size.

The skilled person will appreciate that further variations of the described driving apparatus may comprise more than two output supply terminals. Thus, an output supply interface may comprise more than two output supply terminals. Each output supply terminal is connected to the power supply, and is configured to receive a supply signal (preferably a different supply signal) therefrom. Each supply signal provided to the more than two output supply terminals may have one or more different electrical characteristics to any of the other supply signals.

This approach provides increased flexibility and choice for selecting an electrical characteristic of a supply signal that drives any LED arrangement connected to the driving apparatus.

It will be appreciated that each supply terminal may be associated with a set of one or more interconnection terminals. In particular, each supply terminal may be configured to, when connected to one of the associated set of one or more interconnection terminals via a particular detachable interconnection component, allow the supply signal received at the supply terminal to flow from the supply terminal to the connected interconnection terminal, The particular detachable interconnection component is configured to be detachable from the said supply terminal and/or each of the associated set of one or more interconnection terminals.

For each supply terminal, the associated set of one of more interconnection terminals may comprise all the interconnection terminals. Alternatively, the associated set of one of more interconnection terminals may comprise a subset (i.e., not all) of the interconnection terminals, e.g., a single interconnection terminal.

Similarly, it will be appreciated that some variations of the described driving apparatus may comprise more than two LED interfaces, e.g., for more than two LED arrangements. This approach provides further functionality and connectivity for a driving apparatus. Each LED interface will be electrically connected to a different interconnection terminal, such that the driving apparatus more comprise more than two interconnection terminals.

In any above described embodiment, one or more terminals of any interface may comprise a wire terminal. A wire terminal is a terminal or terminal that is able to able to detachably receive a wire or jump wire (e.g., a detachable interconnection component), e.g., using a clipping mechanism or the like.

There is also proposed an LED driver kit comprising any herein described driving apparatus; and at least one detachable interconnection component. The detachable interconnection component may be a jump wire.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A driving apparatus with a housing comprising:
a power supply, contained inside the housing, configured to provide a first supply signal and a second supply signal;
at least one LED interface on the housing, each LED interface being configured to connect to a respective LED arrangement;
at least one interconnection terminal on the housing, each interconnection terminal being electrically connected to a respective LED interface,
a first supply terminal on the housing and being connected to the power supply and configured to receive the first supply signal from the power supply;
a second, different supply terminal on the housing and being connected to the power supply and configured to receive the second supply signal from the power supply;
wherein:
the first supply terminal and the second supply terminal and each interconnection terminal are distanced with each other on the housing and are manually connectable to an external detachable interconnection component different from the LED arrangement and allow, when one of the supply terminals is connected to a particular interconnection terminal via the detachable interconnection component, the corresponding supply signal to flow to the LED interface connected to the particular interconnection terminal via the connected supply terminal and particular interconnection terminal.

2. The driving apparatus of claim 1, wherein, for each supply terminal, a distance between the connected supply terminal and particular interconnection terminal is no less than a creepage distance corresponding to a voltage of the supply signal provided to the supply terminal, and
the first supply terminal and the second supply terminal and each interconnection terminal are on an external surface of the housing.

3. The driving apparatus of claim 1, wherein the power supply is a non-isolated power-supply.

4. The driving apparatus of claim 1, wherein one of the interconnection terminals is fixedly attached to a first detachable interconnection component while
the first supply terminal and/or second supply terminal is attachably and detatchably connectable to the first detachable interconnection component.

5. The driving apparatus of claim 1, wherein:
the first supply terminal or second supply terminal is fixedly attached to a second detachable interconnection component while
the interconnection terminal is attachably and detatchably connectable to the second detachable interconnection component.

6. The driving apparatus of claim 1, wherein each of the supply terminals and interconnection terminals is attachably and detachably connectable to a third detachable interconnection component.

7. The driving apparatus of claim 1, comprising:
a first LED interface configured to connect to a first LED arrangement,
a second, different LED interface configured to connect to a second LED arrangement,
a first interconnection terminal electrically connected to the first LED interface, and
a second interconnection terminal electrically connected to the second LED interface,
wherein the first supply terminal is adapted to be connectable to the first interconnection terminal via a detachable interconnection component, and the second supply terminal is adapted to be connectable to the second interconnection terminal via another detachable interconnection component.

8. The driving apparatus of claim 7, wherein the first LED arrangement is configured to generate light having at least one different characteristic from that of the second LED arrangement, preferably wherein the at least one different characteristic is a color and/or color temperature; and
either one or both of the first and second interconnection terminals are connectable to the corresponding supply terminal via a detachable interconnection component, so as to provide a selected one or both of the first and the second LED arrangement with one or both of the first and second supply signals respectively.

9. The driving apparatus of claim 1, wherein both of the first supply terminal and the second supply terminal are adapted to be connectable to the interconnection terminal via a detachable interconnection component,
the power supply comprises a current setting arrangement configured to set a first current for the first supply signal and a second, different current for the second supply signal, and
wherein a selected one of the first and second supply terminals is adapted to connect to a detachable interconnection component with the interconnection terminal, so as to provide the LED arrangement with a selected one of the first supply signal and the second supply signal.

10. The driving apparatus of claim 9, wherein:
the current setting arrangement comprises a series interconnection of current setting resistances;
the first supply terminal is connected in series to a first tap in the series interconnection of current setting resistances; and
the second supply terminal is connected in series to a second, different tap in the series interconnection of current setting resistances.

11. The driving apparatus of claim 1, wherein the terminals are wire terminals.

12. An LED driver kit comprising:
the driving apparatus of claim 1; and
at least one detachable interconnection component.

13. The LED driver kit of claim 12, wherein the detachable interconnection component is a jump wire.

14. An LED luminaire comprising:
the LED driver kit of any of claim 12; and
a first LED arrangement comprising one or more light emitting diodes, the first LED arrangement being connected to a first one of the at least one LED interfaces.

15. The LED luminaire of claim 14, wherein the at least one LED interfaces comprises two or more LED interfaces and further comprising a second, different LED arrangement connected to a second, different one of the at least one LED interfaces.
